(19) United States
(12) Patent Application Publication
(10) Pub. No.: US 2008/0098214 A1
(43) Pub. Date: Apr. 24, 2008

(54) Encryption/decryption method, method for safe data transfer across a network, computer program products and computer readable media

(76) Inventors: Antonio Rodriguez Martinez, Elche (ES); Celso Ignacio Barrutia Navarrete, Murcia (ES); Ricardo Nelson Chacin Troconiz, El Palmar (ES)

Correspondence Address: RATNERPRESTIA, P O BOX 980, VALLEY FORGE, PA, 19482-0980, US

(21) Appl. No.: 11/585,693

(22) Filed: Oct. 24, 2006

(51) Int. Cl. H04L 9/00

(52) U.S. Cl. 713/156; 713/173; 713/176

(57) ABSTRACT

An encryption/decryption method is disclosed. The method comprises: using at least one public encryption algorithm for encrypting/decrypting data by using an encryption key, and using a digital certificate for obtaining the encryption key, being the digital certificate one intended for a purpose of guaranteeing a user's identity, with at least one field including a safe combination of bytes predetermined for containing a guarantee key intended for the purpose of guaranteeing the user's identity. The method also comprises a) selecting, according to at least one predetermined steganographic criterion, a subset of the bits of the field with the guarantee key and/or of at least another field of at least the digital certificate also including a safe combination of bytes but not containing the guarantee key, and b) generating from at least the selected bits the encryption key.

### TECHNICAL FIELD

The present invention relates to an encryption/decryption method, to a method for safe data transfer across a network, to computer program products and to computer readable media adapted to carry out said methods.

### BACKGROUND OF THE INVENTION

Nowadays a lot of the information we manage and send is in a digital form, whether just to store it in logical drives of computing devices, or also to send it through a network, such as internet, to a second party.

Some of said information can be considered as critical and wanted to be kept completely private, even when travelling from a first party to a second party, from an undesired access by a third party.

For that purpose different security methods have been developed and used providing different degrees of protection to data.

Some of said methods refer to the use of diverse encryption techniques, such as AES, DES, etc., whether the information to be encrypted is going to be kept locally stored or going to be sent through a network, while others are focused particularly on said sending through a network, providing mechanisms which verify the origin and/or integrity of the data sent or created by a first party to a second party, such as the commonly known digital certificates.

US2004/0054907 proposes to provide security to electronic files stored in an externally-accessible memory of a computing device using a secret identification number for the computing device in a secure memory that is not externally-accessible. A random key is associated with a selected electronic file and an encoded key is generated by symmetrically encrypting the random key using the secret identification number. A digital certificate is associated with the electronic file, where the digital certificate contains the encrypted key, such that the electronic file can be accessed only after restoring the random key through decryption of the encrypted key with the secret identification number.

US2005/0138360 proposes a method, system, and computer program product for providing security for files transferred across a network, such as the Internet. In one embodiment, a web service receives a request for content from a partner. The web service contacts a certificate authority to authenticate the partner and retrieves the requested content. The web service then generates a secret key and encrypts the content with the secret key to produce encrypted content. The secret key and the encrypted content are then embedded within a digital certificate issued by the certificate authority by using the public key of a public/private key pair issued by the certificate authority. The digital certificate is then transmitted to the partner where the partner decrypts the digital certificate to obtain the secret key and then uses the secret key to decrypt the encrypted content.

Both of the just described documents propose to use a digital certificate to contain an encryption key which has been used to encrypt content and which will be used to decrypt said content after obtaining said encryption key from said digital certificate, being said content just associated to the digital certificate in the proposal of US2004/0054907, and also embedded in the digital certificate in the proposal of US2005/0138360.

It is not suggested in any of both of the above described documents not to use the digital certificates for their original purpose, i.e. to verify the origin of data.

In both proposals the encryption keys are specifically included in the corresponding digital certificates, said documents do not teach or even suggest incorporating the encryption keys in parts or fields of the digital certificates originally intended for including other kind of data for other purposes, so a hacker who intercepted and managed to open said digital certificates could see that they contain something more than just the usual fields of a digital certificate, being able to at least locate said encryption keys therein.

Therefore it would be desirable to have a safer way of protecting data, also by using a digital certificate but in a way that deceives a hacker if he intercepts the digital certificate, making it impossible for him to realise that there is something more inside the digital certificate than the usual contents intended for authentication operations.

### DESCRIPTION OF THE INVENTION

The present invention provides, in a first aspect, an encryption/decryption method, comprising:

using at least one public encryption algorithm for encrypting/decrypting data by using an encryption key, and

using a digital certificate for obtaining said encryption key, being said digital certificate one intended for a purpose of guaranteeing a user identity, with at least one field including a safe combination of bytes predetermined for containing a guarantee key intended for said purpose of guaranteeing said user identity,

and wherein the method also comprises:

a) selecting, according to at least one predetermined steganographic criterion, a subset of the bits of said field with said guarantee key and/or of at least another field of at least said digital certificate also including a safe combination of bytes but not containing said guarantee key, and

b) generating from at least said selected bits said encryption key.

For some embodiments said field with a safe combination of bytes not containing said guarantee key, is at least one field of the group comprising the next fields: digital fingerprint field, signature algorithm field, or a combination thereof.

For another embodiment said safe combination of bytes is algorithmic information, such as the one which forms said signature algorithm field or any other algorithmic information.

As mentioned in the previous section if a hacker had access to the digital certificate used by the method of the first aspect of the invention, and could manage to open it, he couldn't see that there is something more in said field including a safe combination of bytes than what is originally intended for (because of pertaining to a digital certificate), for example if said field is said guarantee key, he couldn't see there is something different to a guarantee key.

In other words for decrypting the data encrypted according to the first aspect of the invention, by a third undesired party, he should:
know that there is data encrypted with an encryption key obtained from said digital certificate,
access both, the encrypted data and the digital certificate,
manage to open the digital certificate,
know that an encryption key can be obtained from some bytes there in,
find out the steganographic criterion used to obtain said encryption key,
know in which field to apply said criterion to generate the encryption key,
find out the algorithm or algorithms and other possible techniques (as will be explained later) used to encrypt said data.

Obviously the security is hugely increased by the method of the invention, in relation to conventional methods, making it almost impossible to overcome the security level achieved.

A second aspect of the present invention concerns a computer program product in a computer readable media for use in a data processing system, applied to carry out the method according to the first aspect of the invention.

A third aspect of the invention concerns a computer readable media storing at least said computer program product of the second aspect and at least said digital certificate used by the method according to the first aspect of the invention.

For an embodiment of the third aspect of the invention said computer readable media comprises a USB and/or HASP memory key or any other media which allows a secure storing of a digital certificate, such as the x.509 certificate.

The present invention also concerns, in a fourth aspect, a method for safe data transfer across a network, the method comprising:

i) receiving, by a second user, a file containing encrypted data sent by a first user,

ii) retrieving a fingerprint from said file and a fingerprint from a digital certificate of said second user,

iii) establishing for said second user a secure communication with an authorization server,

iv) sending said fingerprints of said second user retrieved in step ii) to said authorization server,

v) checking an authorization list in said authorization server in order to find out if there is an entry of said fingerprints and if said entry means the second user has permission to decrypt said file sent by said first user, and if there is that permission do the next steps:

vi) selecting and sending, from said authorization server, to the second user, data forming a safe combination of bytes, said data related to said first user as it has been used previously by the first user to obtain an encryption key with which said file has been encrypted,

vii) obtaining, for the second user, said encryption key from said data forming a safe combination of bytes received, and

viii) using said encryption key to decrypt, or revert, said encrypted data of said file.

Depending on the embodiment said steps ii) and iii) can be carried out simultaneously or sequentially in any order.

For a preferred embodiment of the method of the fourth aspect of the invention the encryption and decryption of said file it is carried out by applying the method proposed by the first aspect of the invention.

The present invention also concerns, in a fifth aspect, a computer program product in a computer readable media for use in a data processing system, applied to carry out the method according to the fourth aspect of the invention.

A sixth aspect of the invention concerns a computer readable media storing at least said computer program product of the fifth aspect of the invention and at least said second user digital certificate.

Said computer readable media according to said sixth aspect of the invention comprises, for an embodiment, a USB and/or HASP memory key or any other media which allows a secure storing of an x.509 certificate.

### BRIEF DESCRIPTION OF THE DRAWINGS

The previous and other advantages and features will best be understood by reference to the following detailed description of illustrative and not limitative embodiments when read in conjunction with the accompanying drawings, wherein:

FIG. 1 is a flow chart describing an encryption process according to the method of the first aspect of the invention, for an embodiment wherein the digital certificate used is an x.509 certificate,

FIG. 2 is a diagram which represents the architecture used to carry out the method of the fourth aspect of the invention, for an embodiment,

FIG. 3 is a flow chart part of which is representative of a decrypting process according to an embodiment of the method proposed by the first aspect of the invention, and part of which is representative of an embodiment according to the method proposed by the fourth aspect of the invention,

FIG. 4 is a flow chart which represents the process carried out between an authorization server and a user, or client, to create a trusting rule or authorization entry according to the method of the fourth aspect of the invention,

FIG. 5 is a schematic view representing a simplified architecture used to carry out an embodiment of the first aspect of the invention related to automatic encrypting of files entering or being in watched folders,

FIG. 6 is a flowchart explaining the sequence to determinate how encryption services explores a set of watched folders to encrypt new data, maintaining an encrypted mirrored file system, and

FIG. 7 is a deployment diagram to explain the interaction between a first and a second users and an authentication server, when said second user receives an encrypted file from said first user, according to the method of the fourth aspect of the invention.

### DETAILED DESCRIPTION OF SOME EMBODIMENTS

For a preferred embodiment of the invention, concerning to any of the aspects described above, the digital certificate or certificates used are x.509 certificate, or developed ones there from.

As for the encryption algorithm used by the method of the first aspect of the invention it includes, depending on the embodiment, at least one of the next encryption algorithms: AES, Triple DES, or a combination thereof.

For a more developed embodiment said encryption algorithm includes said combination of at least said AES and Triple DES interspersed with some steps consisting of at least: adding some bytes, altering and/or moving part of the set of bytes of said data and digitally signing said data, or a combination thereof.

Referring to the method proposed by the first aspect of the invention, the at least one predetermined steganographic criterion used is at least one of the next criteria: following a predetermined selection sequence, selecting some bits more than once, or a combination thereof.

In an embodiment of the first aspect of the present invention the method comprises, for obtaining said encryption key, using in addition to said digital certificate at least an additional digital certificate and/or signature certificate with corresponding fields including a safe combination of bytes, comprising:

said step a) also selecting, according to at least said at least one predetermined steganographic criterion, or another criterion, a subset of the bits of at least one of said corresponding fields of said additional digital certificate and/or of said signature certificate,

and said step b) generating from all the selected bits said encryption key.

Said generating of step b) can be carried out in several ways, depending on the embodiment, including at least one of the next actions to carry out with the selected bits: combining them according to the same criterion used to select them and/or to another criterion, carrying out at least one arithmetical operation with them, adding other bits obtained from other sources, encrypting the bits selected to generate an encrypted encryption key, obfuscating the bits selected to generate an obfuscated encryption key, or a combination thereof.

All the textual legends shown in the accompanying drawings must be considered as indicating what they mean.

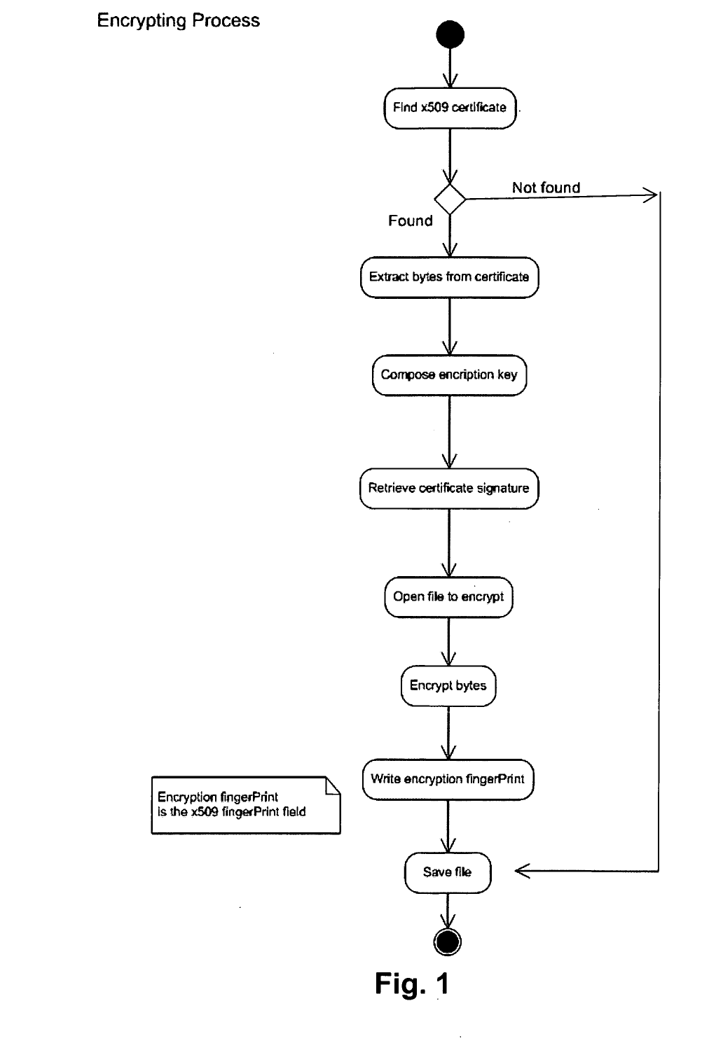

Now referring to FIG. 1, which is a flow chart describing an encryption process according to the method of the first aspect of the invention, for an embodiment wherein the digital certificate used is an x.509 certificate.

The first step of the flow chart of FIG. 1 is finding an x.509 certificate, carrying out the next steps only if that certificate is found (if the certificate is not found a possible file accessed is saved).

Next the encryption key is generated by selectively extracting bytes from the certificate, particularly from a field containing a secure combination of bytes, such as that which contains said guarantee key, i.e. carrying out the step a), and consequently composing the encryption key according to step b) of the method proposed by the first aspect of the invention.

Once the encryption key has been generated, the method of the first aspect of the invention comprises for encrypting said data the following steps, as it is indicated in FIG. 1:
opening a first file containing said data to encrypt,
using said encryption key obtained from said step b) to encrypt said data,
writing an encryption fingerprint on said encrypted data, and
generating a second file with said fingerprinted encrypted data, which is said file saved at the last step of the flow chart of FIG. 1.

For the embodiment of FIG. 1, prior to opening said first file to be encrypted, the certificate signature or fingerprint is retrieved, which is then used to be written on said encrypted data.

For an embodiment the method comprises generating said second file with the same extension of said first file.

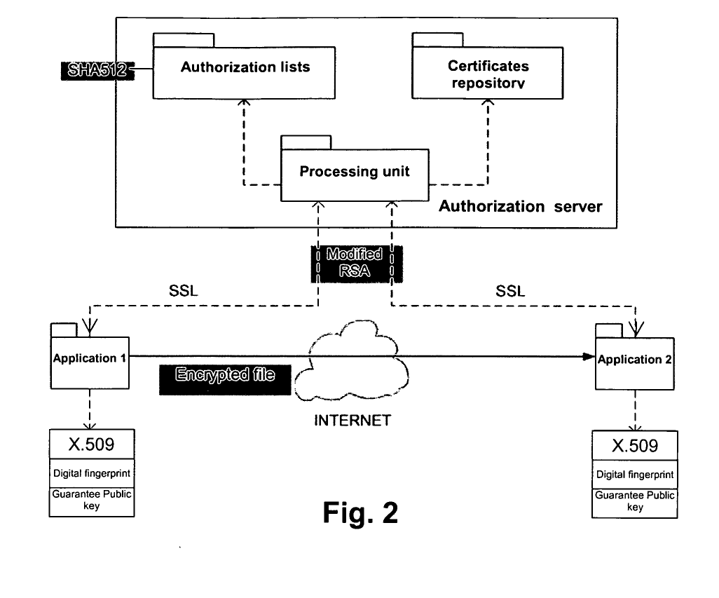

As described above, a second aspect of the present invention concerns a computer program product applied to carry out the method according to the first aspect of the invention, which will be referred as desktop application, or application 1 in FIG. 2, and which is installed, in a preferred embodiment, in a computer readable media, such as a USB and/or HASP memory key, storing also said x.509 certificate.

For another embodiment said desktop application can be installed in a computer instead of in said USB and/or HASP memory key.

When encrypting a file according to the method of the first aspect of the invention and by using both said desktop application (second aspect) and said memory key (third aspect), and a computer it only will begin working if the next conditions are satisfied:
the desktop application is installed in said computer or in the memory key, and
the user wanting to encrypt a file connects the USB/HASP containing the x.509 certificate to a corresponding data port of said computer.

When a user wants to encrypt a file by using said desktop application, he runs said application, which provokes that a verification of the connection of a memory key with a x.509 certificate is carried out (as indicated in the first box of FIG. 1).

Once said certificate is found, the desktop application extracts the information relative to the guarantee public key of the certificate, which has a longer length than the encryption key wanted to be generated, and generates it by using an algorithm in charge of applying said steganographic criterion, said encryption key increasing its robustness because of the next two reasons based in steganography and combinatory:
Due to the fact that said encryption key is not a key written by a user, its values can vary from ASCII 1 to 256, including the non-printable characters, so that the options range is greater.
Although the number of bytes can be other, depending on the embodiment, for a preferred embodiment, from the bytes extracted from the x.509 certificate (590 bytes in the case of the public key field), there are selected 48 which will compose the encryption key, increasing the combinatory so selections can be done with repetitions and without order (590⁴⁸=1,0020665353275723944561113087861e+133 possible combinations).

Once the encryption key has been generated, the desktop application provokes the retrieval of the digital certificate fingerprint which will be used to sign the file with the encrypted data, referred before as second file, as explained previously with reference to FIG. 1, and which will be the base for carrying out the automatic reversion method (explained later).

That signing of the encrypted file will permit always to identify the author of the encrypting, when a second user wants to revert the encrypted file by using a corresponding desktop application which also is able to carry out said author identification.

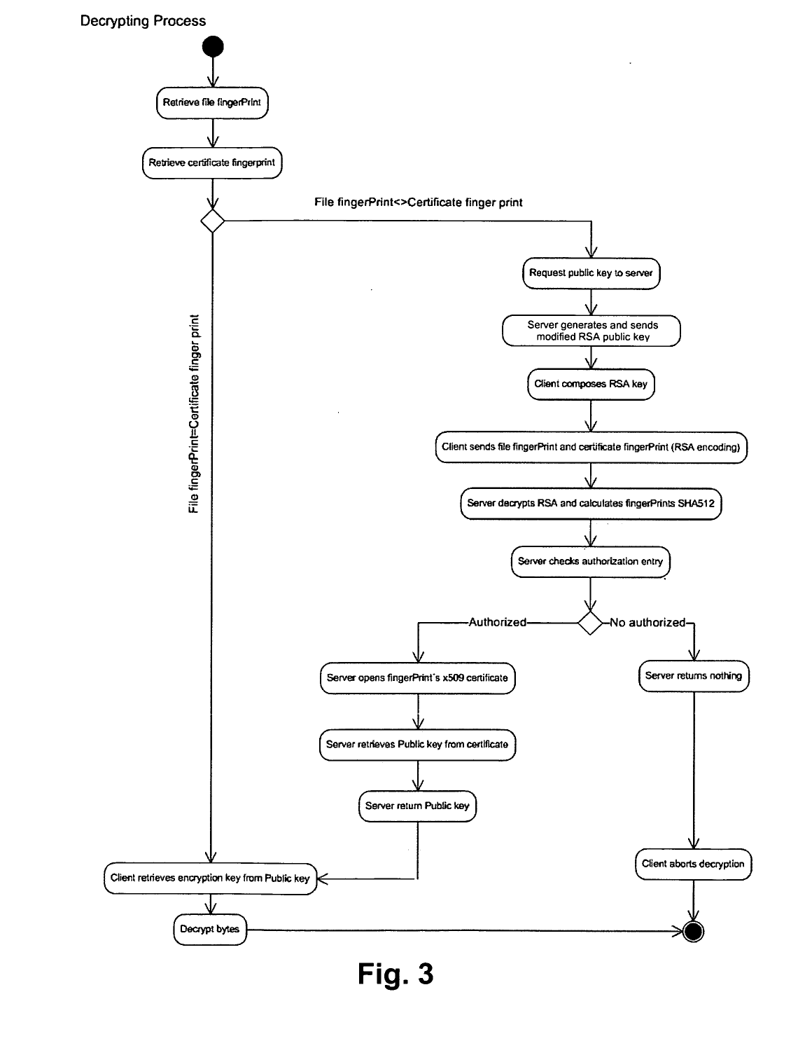

The method proposed by the first aspect of the invention also comprises for decrypting, or reverting, said encrypted data of said second file, the following steps, which are represented by the first two boxes of the flow chart of FIG. 3:
retrieving said fingerprint from said second file and a fingerprint from a digital certificate intended to be used, according to said steps a) and b), to obtain an encryption key to decrypt data,
comparing the second file fingerprint with said intended for decrypting digital certificate fingerprint, and if they match follow the left path of the chart of FIG. 3, i.e.:
carrying out said steps a) and b) with said intended for decrypting digital certificate, and using the encryption key generated to decrypt, or revert, said data of said second file.

Referring also to FIG. 3, there it is detailed the method proposed by the fourth aspect of the invention for an embodiment, which begins as described previously by carrying out the steps:

i) receiving, by a second user, a file containing encrypted data sent by a first user,

ii) retrieving a fingerprint from said file and a fingerprint from a digital certificate of said second user,

and which although it can go unconditionally on with the next steps iv) to viii), for the embodiment illustrated by FIG. 3 said carrying out of the steps iv) to viii) is conditioned to a previous step, after said step ii) and before said step iii), which comprises comparing said file fingerprint and said second user digital certificate fingerprint, and:
if they don't match carrying out the step iii) and the consequent ones iv) to viii),
or
if they match carrying out the method of the first aspect of the invention, doing said steps a) and b) with said second user digital certificate, and using the encryption key generated to decrypt, or revert, said data of file received in step i).

Although not limited to it, said fingerprints matching usually happens when the first and the second users are the same user, i.e. the user who has previously encrypted said data and who will decrypt it afterwards.

As for the secure communication established in said step iii) by said second user with an authorization server, for an embodiment it is based at least on a RSA algorithm, using said second user a RSA public key, modulus and exponent, received from the authorization server after a corresponding request, to encode said fingerprints retrieved in step ii) and send them encoded in said step iv), said authorization server decoding said fingerprints before carrying out said step v).

For the preferred embodiment of FIG. 3 said secure communication established in said step iii) is based on a modified RSA algorithm, being said step iii) carried out, in a sequential manner, by the following sub-steps, indicated in FIG. 3 as:
Request public key to server: requiring, said second user, a public key to said authorization server,
Server generates and sends modified RSA public key:
   generating said authorization server, from a RSA public key, a set of data formed by a safe combination of bytes, said set of data including the bits which form the modulus and exponent of the RSA public key mixed and dispersed between other bits according to at least one predetermined steganographic criterion,
   sending sequentially, the authorization server, said set of data to the second user,
Client composes RSA key: composing, the second user, said RSA public key by selecting, according to said at least one predetermined steganographic criterion, a subset of the bits of said set of data received,
Client sends file fingerprint and certificate fingerprint (RSA encoding): using, said second user, said RSA public key, modulus and exponent, to encode said fingerprints retrieved in step ii) and send them encoded in said step iv),
Server decrypts RSA and calculates fingerprints SHA512: said authorization server decoding said fingerprints before carrying out said step v),

Note: The SHA512 indication refers to the fact that, for an embodiment, the server uses an SHA algorithm to carry out an encryption/decryption of fingerprints, as will be explained later, although for other embodiments that SHA algorithm is not used.

Following with the right path of FIG. 3, the next step of the method of the fourth aspect of the invention is the step v), i.e. checking in an authorization list if there is an entry of said fingerprints and if said entry means the second user has permission to decrypt said file sent by said first user.

In the case there is no such entry (“no authorized” path in FIG. 3), the method of the fourth aspect comprises to consider that fact as the second user is not authorized to decrypt the file, so the authorization server returns nothing to second user, and then said second user, or client, aborts decryption, preferably automatically by using a corresponding desktop application.

If there is that permission (“authorized” path in FIG. 3), the authorization server carries out the step vi), comprising for the illustrated embodiment of FIG. 3 opening the first user fingerprint's x.509 certificate, retrieving a guarantee public key from said first user certificate, and sending it to the second user (indicated as “server return public key” in FIG. 3).

Once the second user has received said guarantee public key, it carries out, by using said corresponding desktop application, said steps vii) and viii), after which the contents of encrypted file are decrypted.

In order to enhance said secure communication established in said step iii) by the second user with the authorization server, for an embodiment the method of the fourth aspect of the invention comprises using also a SSL protocol for that communication.

Although the method of the fourth aspect of the invention can be carried out whatever the encryption method used to encrypt said data of file received in step i), for a preferred embodiment the encryption/decryption method used is the one proposed by the first aspect of the invention, in which case:

said file received in step i) is said second file generated by said first user according to the method of the first aspect of the invention,

said digital certificate of said second user used in said step ii) is one intended for a purpose of guaranteeing said second user identity,

said data forming a safe combination of bytes selected by the authorization server in step vi) are those, or a copy of those, included in said field of the first user digital certificate to obtain said encryption key according to the method of the first aspect of the invention, and

said encryption key is obtained in said step vii) according to the method of the first aspect of the invention, by carrying out the corresponding steps a) and b).

Referring now to the authorization checked by the authorization server in said step v), the method of the fourth aspect comprises generating at least part of said authorization list by said first user, in collaboration with the authorization server, referring at least to permissions assigned to said second user.

For that purpose, i.e. in order to generate said part of the authorization list referred to the permissions assigned, by the first user, to the second user, the method comprises to send, said first user to the authorization server, its digital certificate fingerprint and the second user digital certificate fingerprint.

For the cases in which said first user wants to allow not only a second user but a plurality of users to decrypt data encrypted by the first user, the method of the fourth aspect of the invention comprises, in order to generate part of the authorization list referred to the permissions assigned, by the first user, to said plurality of other users, to send, said first user to the authorization server, its digital certificate fingerprint and the digital certificates fingerprints of said plurality of users.

The method of the fourth aspect comprises to establish a secure communication between the first user and the authorization server, to be used for said fingerprints sending.

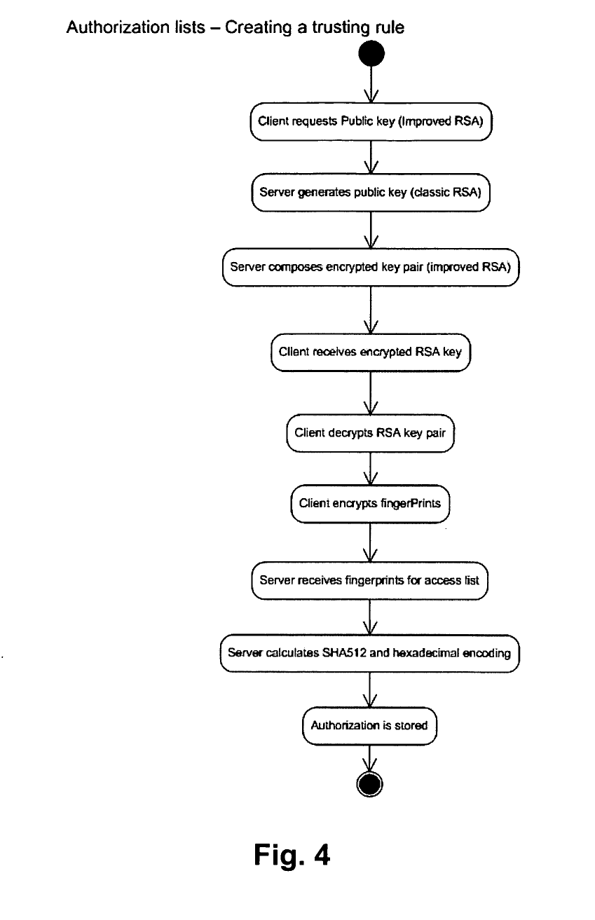

Said secure communication is, for a preferred embodiment, established based at least on a modified RSA algorithm, and carried out, in a sequential manner, by means of the following sequential sub-steps shown in the flow chart of FIG. 4:
requiring, said first user to obtain a public key from said authorization server, indicated in FIG. 4 as “Client requests public key (Modified RSA)”,
generating by said authorization server a classic RSA public key,
generating or composing by said authorization server, from said classic RSA public key, a set of data formed by a safe combination of bytes, said set of data including the bits which form the modulus and exponent of the RSA public key mixed and dispersed between other bits according to at least one predetermined steganographic criterion,
sending sequentially, from the authorization server, said set of data to the first user, who receives it,
composing, by the first user, said RSA public key by selecting, according to said at least one predetermined steganographic criterion, a subset of the bits of said set of data received, in other words decrypting the RSA key pair, modulus and exponent (as it is indicated in FIG. 4), and
using, by said first user, said RSA public key, modulus and exponent, to encode or encrypt said fingerprints he desires to send and sending them encoded to the authorization server, the authorization server receiving and decoding said fingerprints and incorporating them in said authorization list.

The differences between a classic RSA public key process and the one which uses the modified RSA algorithm of the invention described just above, and the advantages of the latter, are, for a better comprehension, described next.

When initiating a classic RSA public key ciphering common process the server or owner of the private key must send to the client or user the public key composed by the two fields (modulus and exponent) from which the client will calculate the key.

The modified RSA system used by the method of the fourth aspect of the invention comprises sending just one sequence with both fields mixed, so even if someone intercepted the assigned key, he couldn't make an attack of the kind of identity impersonation, due to the fact that the attacker wouldn't know which bytes correspond to each field, hence not being able to establish a correct communication with the server.

For an embodiment the employed RSA uses, in order to increase the steganographic complexity a key of 384 bytes, therefore the probability of finding out the division of the fields is 1/21,743,271,936 [384⁴].

In order to increase the security of the data of the authorization list, the method of the fourth aspect of the invention comprises to encrypt, by said authorization server, said fingerprints before incorporating them in the authorization list.

In the embodiment illustrated by the flow chart of FIG. 4, the authorization server uses an SHA algorithm to carry out said encryption of fingerprints and a hexadecimal encoding, and finally stores the encrypted and encoded fingerprints in the authorization list associated to the corresponding permissions. As a result, even if an attacker could access directly the authorization list, he couldn't identify their entries.

The method of the fourth aspect comprises to establish said secure communication between the first user and the authorization server, to be used for said fingerprints sending, also based on a SSL protocol.

The method also comprises to revoke an authorization or permission at any moment, preventing the receiver of an encrypted file from decrypting it, or, for another embodiment to provide temporal permissions.

Although the description of the creation of the authorization list has been done only referring to a first user, the method of the fourth aspect of the invention comprises, for an embodiment, generating at least part of said authorization list by a plurality of users, each selectively assigning permissions to desired users.

As described above a fifth aspect of the present invention concerns to a computer program product applied to carry out the method according to the fourth aspect of the invention, which will be referred as desktop application, or application 2 in FIG. 2, and which is installed, in a preferred embodiment, in a computer readable media, such as a USB and/or HASP memory key, storing also said x.509 certificate.

For another embodiment said desktop application, or application 2, can be installed in a computer instead of in said USB and/or HASP memory key.

Similarly to the way the desktop application (application 1 in FIG. 2) of the method of the first aspect of the invention works, when wanting to decrypt a file according to the method of the fourth aspect of the invention and by using both said desktop application (application 2 in FIG. 2) of the fifth aspect, said memory key of the sixth aspect and a computer, it only will begin working if the next conditions are satisfied:
the desktop application is installed in said computer or in the memory key, and
the user wanting to decrypt a file connects the memory key containing the digital certificate to a corresponding data port of said computer.

When a user wants to decrypt a file by using said desktop application, he runs said application 2, which provokes that a verification of the connection of a memory key with a x.509 certificate is carried out.

Once said certificate is found, the desktop application retrieves the digital fingerprints of both, the encrypted file (referred as second file previously) and the one of the digital certificate stored in the memory key of the sixth aspect of the invention, i.e. carries out the already explained first two steps of the flow chart of FIG. 3, and go on automatically with the rest of the steps indicated in FIG. 3 and described previously.

FIG. 2 is a schematic view which shows an architecture used to carry out the method of the fourth aspect of the invention, for an embodiment, wherein the first user desktop application, referred as application 1, has access to a x.509 certificate which contains a corresponding digital fingerprint and a guarantee public key, and is sending through Internet a file, which is encrypted according to the method of the first aspect, to the second user, the latter having a user desktop application, referred as application 2 with access to a corresponding x.509 certificate which also contains a corresponding digital fingerprint and a guarantee public key (this second user guarantee key not necessary to be used for decrypting).

It can be seen in FIG. 2 that both users, in fact both applications 1 and 2, are in communication with the authorization server through the described secure communications channel, based on SSL algorithms and through the already described modified RSA algorithms, for the reasons already described (the first user for providing decryption permissions and the second user to interact with the server as it has been explained previously).

Said authorization server is schematically divided in three blocks in FIG. 2:—one which contains a processing unit in charge of carrying out the actions already described, and to manage the other two blocks described below, which are:
a memory block wherein the authorization lists are stored encrypted with a SHA512 algorithm, as it has been already described, and
a certificates repository where there are stored copies of the digital certificates used for encryption/decryption according to the method of the first aspect, and received from the first user and sent to the second user (if he has permission).

Obviously the denominations of “first user” as the one who encrypts a file, and “second user” as the one who decrypts said file, only have been used to describe more clearly the methods proposed, but any user can carry out both the encryption and the decryption actions according to the methods proposed, for which it is preferred that both desktop applications (application 1 and application 2, see FIG. 2), are equal (or very similar) and hence able to carry out the encryption, decryption, and interaction with the authorization server, as it has been already explained.

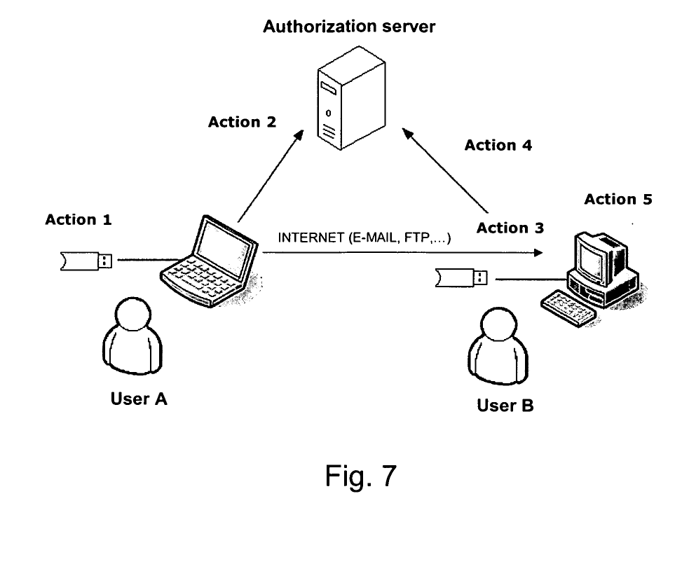

FIG. 7 is a simplified diagram which represents the interaction between a first and a second users (users A and B) and an authentication server, according to the method of the fourth aspect of the invention.

Said users A and B have each a computer with the already described desktop applications installed in (or at least a direct access to said applications), and respective memory keys, each with a respective digital certificate.

In said FIG. 7 there are five actions indicated which represent in a simple manner the methods of the first and fourth aspect of the invention for an embodiment. Those actions are:

Action 1: User A introduces his memory key into a port of his computer, and encrypts some files with his desktop application according to the method of the first aspect of the invention.

Action 2: User A allows user B to decrypt files, by creating the adequate authorization entry with the collaboration of the authorization server, according to the method of the fourth aspect of the invention.

Action 3: User B receives an encrypted file sent by user A through Internet (e-mail, FTP, etc. . . . ).

Action 4: User B introduces his memory key into a port of his computer, and by using his desktop application detects a different encryption signature, or fingerprint, in the received file from the one of user B digital certificate, and requests to the authorizations server the user A certificate. If exists a permission from user A to user B to decrypt files, user B receives a temporary copy of user A certificate.

Action 5: If user B receives the copy of the user A certificate, then he can decrypt the received encrypted file.

Following with the method of the first aspect of the invention, and in order to automate the encryption process, the method of the first aspect of the invention comprises:
assigning one or more zones of a first memory to one or more user folders,
   automatically watching said user folder or folders, and
   automatically encrypting data of any file being stored in said memory zone or zones assigned to said at least one user folder, by opening said file, accessing the user digital certificate and obtaining the encryption key used to encrypt said data by carrying out the steps a) and b) already described.

For an embodiment the method of the first aspect comprises after said automatic encryption, storing the encrypted file in a zone of said first or of a second memory related to an encrypted files user folder.

Depending on the embodiment, after said storing of said encrypted file, the method of the first aspect comprises deleting the original non-encrypted file or keeping it non-encrypted or encrypted.

As far as said memories are concerned, they are logical disks or whatever of other kind of memory a person skilled in the art would consider convenient.

For an embodiment said automatic steps are carried out at least in part by a server, being said first memory part of a computer of said user and said second memory part of said server.

A variant of said embodiment described in the last paragraph comprises to carry out an authentication process for communicating said user computer and said server.

For another embodiment said automatic steps are carried out locally by a computer of said user, being said first memory or said first and second memories part of said user computer.

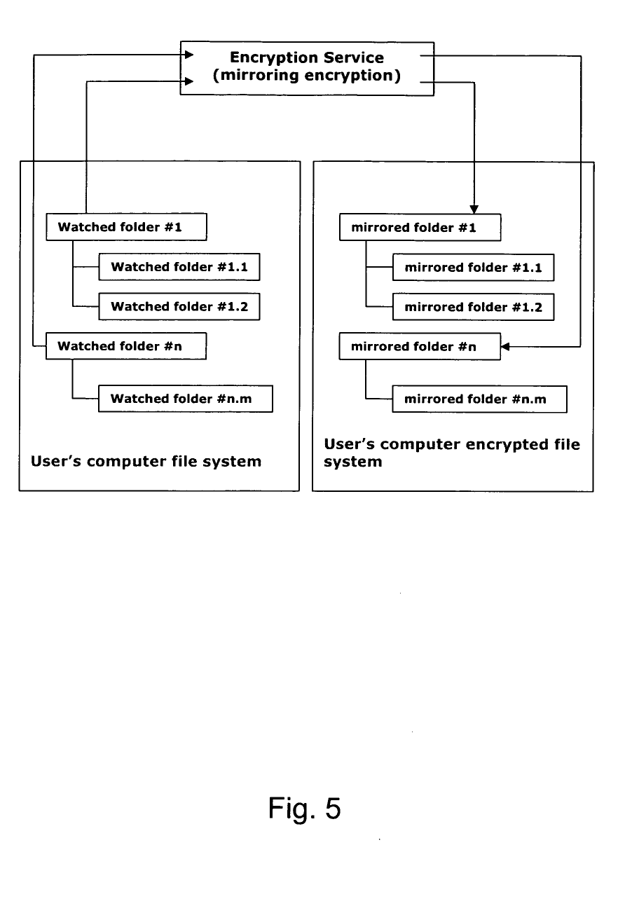

FIG. 5 is a schematic view representing a simplified architecture used to carry out an embodiment of the first aspect of the invention related to said automatic encrypting of files entering or being in watched folders.

In the embodiment of FIG. 5 the automatic encryption is carried out using one or more memories defining two zones:
said memory zone to be watched, locally, located in the user's computer, labelled in FIG. 5 as “User's computer file system”, having n watched folders (#1 and #n) each with respective subfolders (#1.1-#1.2, #n.m), and
said memory zone into which to store the encrypted files, labelled in FIG. 5 as “User's computer encrypted file system”, having n mirrored folders (#1 and #n) each with respective subfolders (#1.1-#1.2, #n.m).

In said FIG. 5 there is also a block labelled as “Encryption service (mirroring encryption)”, in connection with the mentioned two memory zones.

For the illustrated embodiment said encryption service watches said watched folders and encrypts files stored therein each time they are stored into said watched folders. The encryption service stores the encryption files into said mirrored folders, hence having, for said embodiments, the original files in a plain form in said watched folders, and a copy of them (or a mirror) in an encrypted form into said mirrored folders.

Mirrored folders may be:

User's local filesystem, just selecting the mirroring root as a file on the local filesystem.

Local network backup server, over network logical or physical drives.

Remote network back up server, known as e-back up (since file is already encrypted, could be sent through an unsecured network safely).

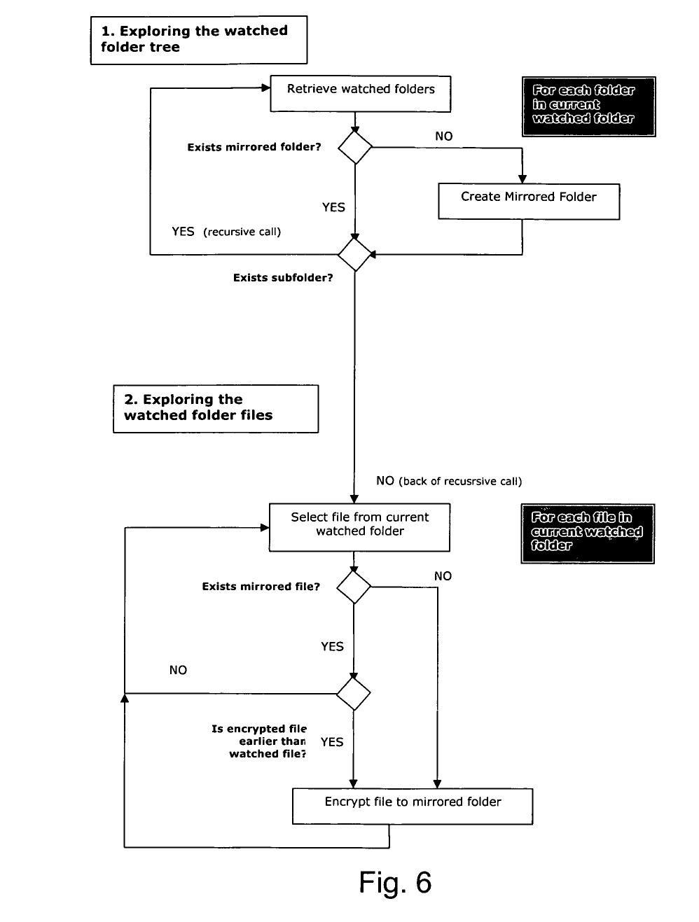

FIG. 6 is a flowchart showing a sequence to determinate how encryption services explores a set of watched folders to encrypt new data, maintaining an encrypted mirrored file system, for an embodiment.

Said flow chart is divided into two main parts: a first one related to the exploration of the watched folder tree, and a second one for the exploring of the watched folder files.

The flow chart begins with the action of retrieving watched folders and, for each folder retrieved, face the first disjunctive asking if “exists mirrored folder” for the retrieved watched folder.

If the answer to said first disjunctive is negative, a corresponding mirrored folder is created, and if the answer to the first disjunctive is affirmative then there is checked out if the retrieved watched folder have corresponding subfolders, by means of a second disjunctive “exists subfolder”. If the answer to the second disjunctive is affirmative then a recursive call is done, carrying out again the first action of the flow chart to retrieve also the subfolders found.

If the answer to the second disjunctive is negative then the second part of the flow chart related to exploring watched folder files is initiated by selecting a file from current watched folder (or subfolder if that's the case). That action is done for each file in current watched folder.

The third disjunctive is faced in the form of the question “exists mirrored file?”. If the answer is negative, then the selected file is encrypted and stored into the corresponding mirrored folder, and if the answer is affirmative then date and time of creation of the mirrored file and of the file selected is compared, what is represented in FIG. 6 by the fourth disjunctive “Is encrypted file earlier than watched file?”.

If the answer to the fourth disjunctive is affirmative then the selected file is encrypted and stored in the corresponding mirrored folder, and if the answer is negative then another file is selected from the current watched folder.

After the encryption and storing of the selected file the selection of other files from the current folder is sequentially done until there are no more files inside said folder, then beginning again the flow chart process for the rest of watched folders.

That process is continuously carried out in order to encrypt any new file which is introduced into any of the watched folders as quickly as possible without having the user to ask for that encryption, but only to select previously the folders he wants to be watched by the encryption service, which can be an application installed in the user's computer or a hardware device or server with a corresponding application installed there in.

To revert or decrypt a file automatically encrypted by said encryption service, it can be carried out by a user according to the method of the first aspect of the invention in the case it was encrypted from said user watched folders, or by applying the method of the fourth aspect of the invention if the user who wants to decrypt it is not the one who had said file located in a watched folder in order to be encrypted.

A person skilled in the art could introduce changes and modifications in the described embodiments, without departing from the scope of the invention as described in the enclosed claims.

1. An encryption/decryption method, of the type comprising:
using at least one encryption algorithm for encrypting/decrypting data with an encryption key,
using a digital certificate for obtaining said encryption key,
wherein said digital certificate is one intended for a purpose of guaranteeing a user identity, with at least one field including a safe combination of bytes predetermined for containing a guarantee key intended for said purpose of guaranteeing said user identity, and wherein the method comprises:
a) selecting, according to at least one predetermined steganographic criterion, a subset of the bits of said at least one field with said guarantee key and/or of at least another field of at least said digital certificate also including a safe combination of bytes but not containing said guarantee key, and
b) generating from at least said selected bits said encryption key.

2. The method of claim 1, wherein said field with a safe combination of bytes not containing said guarantee key, is at least one field selected from the group consisting of a digital fingerprint field, a signature algorithm field, or a combination thereof.

3. The method of claim 1, wherein said safe combination of bytes is algorithmic information.

4. The method of claim 1, wherein said at least one predetermined steganographic criterion is at least one of the next criteria: applying a predetermined selection sequence, selecting some bits more than once, or a combination thereof.

5. The method of claim 1, wherein said digital certificate is a x.509 certificate, or a certificate developed there from.

6. The method of claim 1, wherein said encryption algorithm includes at least a combination of at least an AES and a Triple DES encryption algorithms interspersed with some steps consisting of at least: adding some bytes, altering and/or moving at least a portion of the set of bytes of said data and digitally signing said data, or a combination thereof.

7. The method of claim 1, wherein it comprises, for obtaining said encryption key, using in addition to said digital certificate at least an additional digital certificate and/or signature certificate with corresponding fields including a safe combination of bytes, comprising:
said step a) also selecting, according to at least said at least one predetermined steganographic criterion, or another criterion, a subset of the bits of at least one of said corresponding fields of said additional digital certificate and/or of said signature certificate,
and said step b) generating from all the selected bits said encryption key.

8. The method of claim 7, wherein said generating of step b) includes at least one of the next actions to carry out with the selected bits: combining them according to the same criterion used to select them and/or to another criterion, carrying out at least one arithmetical operation with them, adding other bits obtained from other sources, encrypting the bits selected to generate an encrypted encryption key, obfuscating the bits selected to generate an obfuscated encryption key, or a combination thereof.

9. The method of claim 1, wherein said generating of step b) includes at least one of the next actions to carry out with the selected bits: combining them according to the same criterion used to select them and/or to another criterion, carrying out at least one arithmetical operation with them, adding other bits obtained from other sources, encrypting the bits selected to generate an encrypted encryption key, obfuscating the bits selected to generate an obfuscated encryption key, or a combination thereof.

10. The method of any of claim 1, wherein it comprises for encrypting said data the following steps:
opening a first file containing said data,
using said encryption key obtained from said step b) to encrypt said data,
writing an encryption fingerprint on said encrypted data, and
generating a second file with said fingerprinted encrypted data.

11. The method of claim 10, wherein it comprises obtaining said fingerprint by retrieving it from said at least one digital certificate.

12. The method of claim 10, where it comprises for decrypting, or reverting, said encrypted data of said second file, the following steps:
retrieving said fingerprint from said second file and a fingerprint from a digital certificate intended to be used, according to said steps a) and b), to obtain an encryption key to decrypt data,
comparing both retrieved fingerprints, and if they match:
carrying out said steps a) and b) with said digital certificate intended to be used to obtain an encryption key to decrypt data, and using the encryption key generated to decrypt, or revert, said data of said second file.

13. A method for safe data transfer across a network, the method comprising:
i) receiving, by a second user, a file containing encrypted data sent by a first user,
ii) retrieving a fingerprint from said file and a fingerprint from a digital certificate of said second user,
iii) establishing a secure communication between said second user and an authorization server,
iv) sending said fingerprints of said second user retrieved in step ii) to said authorization server,
v) checking an authorization list in said authorization server in order to find out if there is an entry of said fingerprints and if said entry means the second user has permission to decrypt said file sent by said first user, and if there is that permission do the next steps:
vi) selecting and sending, from said authorization server, to the second user, data forming a safe combination of bytes, said data related to said first user as it has been used previously by the first user to obtain an encryption key with which said file has been encrypted,
vii) obtaining, for the second user, said encryption key from said data forming a safe combination of bytes received, and
viii) using said encryption key to decrypt, or revert, said encrypted data of said file.

14. The method of claim 13, wherein said steps ii) and iii) can be carried out simultaneously or sequentially in any order.

15. The method of claim 13, wherein:
said file received in step i) is a second file which has been generated by said first user by carrying out the following steps:
opening a first file containing non-encrypted data,
using an encryption key to encrypt said data,
writing an encryption fingerprint on said encrypted data, and
generating said second file with said fingerprinted encrypted data,
wherein the method used to carry out said data encryption is an encryption/decryption method which comprises:
using at least one encryption algorithm for encrypting/decrypting data with an encryption key,
using a digital certificate for obtaining said encryption key, being said digital certificate one intended for a purpose of guaranteeing said first user identity, with at least one field including a safe combination of bytes predetermined for containing a guarantee key intended for said purpose of guaranteeing said first user identity, and wherein said encryption/decryption method is carried out by doing the next steps:
a) selecting, according to at least one predetermined steganographic criterion, a subset of the bits of said at least one field with said guarantee key and/or of at least another field of at least said first user digital certificate also including a safe combination of bytes but not containing said guarantee key, and
b) generating from at least said selected bits said encryption key, being said encryption key the one used by said first user to carry out said data encryption,
being said digital certificate of said second user used in said step ii) one intended for a purpose of guaranteeing said second user identity,
being said data forming a safe combination of bytes selected by the authorization server in step vi) those, or a copy of those, included in said field of the first user digital certificate used in said step a),
being said encryption key obtained in said step vii) by said second user by carrying out said steps a) and b) of said encryption/decryption method on said data received from the authorization server in step vi),
and being said fingerprint retrieved in said step ii) from said file received in said step i) said encryption fingerprint written on said encrypted data by the first user.

16. The method of claim 13, wherein it comprises generating at least part of said authorization list by said first user, in collaboration with the authorization server, referring at least to permissions assigned to said second user.

17. The method of claim 16, wherein in order to generate said part of the authorization list referred to the permissions assigned, by the first user, to the second user, it comprises to send, from said first user to the authorization server, its digital certificate fingerprint and the second user digital certificate fingerprint.

18. The method of claim 17, wherein in order to generate part of the authorization list referred to the permissions assigned, by the first user, to a plurality of other users, it comprises to send, from said first user to the authorization server, its digital certificate fingerprint and the digital certificates fingerprints of said plurality of users.

19. The method of claim 17, wherein said fingerprints sent by the first user are sent through a secure communication.

20. The method of claim 13, wherein said permission is temporal.

21. The method of claim 13, wherein it comprises generating at least part of said authorization list by a plurality of users, each selectively assigning permissions to desired users.

22. The method of claim 13, wherein it comprises after said step ii) and before said step iii), comparing said file fingerprint and said second user digital certificate fingerprint, and:
if they don't match carrying out the step iii) and the consequent ones iv) to viii), or
if they match, and in order to decrypt, or revert, said data of said files received in step i), carry out an encryption/decryption method which comprises:
using at least one encryption algorithm for encrypting/decrypting data with an encryption key,
using a digital certificate for obtaining said encryption key, being said digital certificate one intended for a purpose of guaranteeing said second user identity, with at least one field including a safe combination of bytes predetermined for containing a guarantee key intended for said purpose of guaranteeing said second user identity, and wherein said encryption/decryption method is carried out by doing the next steps:
a) selecting, according to at least one predetermined steganographic criterion, a subset of the bits of said at least one field with said guarantee key and/or of at least another field of at least said second user digital certificate also including a safe combination of bytes but not containing said guarantee key, and
b) generating from at least said selected bits said encryption key, and using the encryption key generated to decrypt, or revert, said data of file received in step i).

23. The method of claim 22, wherein when said comparison offers as a result that said fingerprints match, the method comprises establishing that said first user and said second user are the same user, which has both previously encrypted said file and decrypts it afterwards.

24. A computer program product in a computer readable media for use in a data processing system, applied to carry out the method according to claim 22.

25. A computer readable media storing at least said computer program product of claim 24 and at least said second user digital certificate.

26. The method of claim 1, wherein it comprises:
assigning at least one zone of a first memory to at least one user folder,
automatically watching said at least one user folder, and
automatically encrypting data of any file being stored in said at least one memory zone assigned to said at least one user folder, by opening said file, accessing said user digital certificate and obtaining said encryption key used to encrypt said data by carrying out the steps a) and b).

27. The method of claim 26, wherein it comprises after said automatic encryption, storing the encrypted file in a zone of said first or of a second memory related to an encrypted files user folder.

28. The method of claim 27, wherein said automatic steps are carried out at least in part by a server, being said first memory part of a computer of said user and said second memory part of said server.

29. The method of claim 27, wherein said automatic steps are carried out locally by a computer of said user, being said first memory or said first and second memories part of said user computer.
